(19) United States
(12) Patent Application Publication
(10) Pub. No.: US 2019/0217602 A1
(43) Pub. Date: Jul. 18, 2019

(54) TRANSFER FILM AND IMAGE FORMING METHOD

(71) Applicant: FUJIFILM Corporation, Tokyo (JP)

(72) Inventors: Hideki KAIMOTO, Fujinomiya-shi (JP); Hiroshi KAWAKAMI, Fujinomiya-shi (JP)

(73) Assignee: FUJIFILM Corporation, Tokyo (JP)

(21) Appl. No.: 16/366,593

(22) Filed: Mar. 27, 2019

Related U.S. Application Data
(63) Continuation of application No. PCT/JP2017/032777, filed on Sep. 12, 2017.

(30) Foreign Application Priority Data
Sep. 28, 2016 (JP) 2016-190045

(51) Int. Cl. B41J 2/005; B41M 5/025

(52) U.S. Cl. CPC B41J 2/0057; B41M 5/0256

(57) ABSTRACT

An object is to provide a transfer film having a support, a protective layer, an image receiving layer, and an ink permeation layer, in which the support can be suitably peeled off after the transfer film is adhered to a printing material, and the scratch resistance of the protective layer is excellent, and an image forming method using this transfer film. The transfer film including the support, the protective layer that is formed on one surface of the support, the image receiving layer that is formed on a surface of the protective layer, and the ink permeation layer that is formed on a surface of the image receiving layer and has voids for allowing permeation of an ink. The protective layer has a thickness of 5 μm or less and contains a polymer having a glass transition temperature of 0° C. or higher is provided.

### CROSS-REFERENCE TO RELATED APPLICATIONS

This application is a Continuation of PCT International Application No. PCT/JP2017/032777 filed on Sep. 12, 2017, which claims priority under 35 U.S.C. § 119(a) to Japanese Patent Application No. 2016-190045 filed on Sep. 28, 2016. The above application is hereby expressly incorporated by reference, in its entirety, into the present application.

### BACKGROUND OF THE INVENTION

### 1. Field of the Invention

The present invention relates to a transfer film capable of receiving an image by ink jet and transferring an image receiving layer (ink receiving layer) to a transferred medium, and an image forming method using the transfer film.

### 2. Description of the Related Art

Since an inkjet method is capable of performing printing at high speed with a simple mechanism, the method has been widely used and it has been attempted to perform printing not only on paper but also on various articles such as cloth or fabric as a printing material.

Along with that, in recent years, it has been required to perform printing on a printing material which has a low ink holding capacity and to which an ink does not easily adhere, such as a member which does not have an ink holding capacity and to which an ink does not easily adhere, for example, a surface of a compact disc (CD) or a digital versatile disc (DVD), a surface of a resin molded product, a surface of a metal product, or a product formed of coated cardboard or corrugated board with low glossiness, by ink jet.

For a method of performing printing by ink jet on such a printing material having a low ink receiving capacity, JP2002-321442A discloses a film in which an image receiving layer and an adhesive layer are laminated (ink jet receiving layer transfer film).

In the film described in JP2002-321442A, the image receiving layer is formed on the surface of the printing material by bonding the film to the printing material with the adhesive layer, and printing is performed on the image receiving layer formed on the printing material by an ink jet method. Thus, it is possible to perform printing on the printing material having a low ink receiving capacity by an ink jet method.

In contrast, in the film described in JP2002-321442A, after the image receiving layer is formed on the printing material by bonding the film to the printing material, printing is performed. Therefore, in the printing on the printing material using the film, it is necessary to complicate the ink jetting direction and the transportation of the printing material according to the shape of the printing material at printing.

As a transfer film for solving such a problem, a transfer film described in JP5864160B is known.

The transfer film described in JP5864160B includes an ink permeation layer which has a jetting surface by an ink jet method, has voids for allowing permeation of an ink from the jetting surface, and is charged to the same polarity as the polarity of the ink so as to promote permeation of the ink in the voids, an image receiving layer (ink receiving layer) which receives the ink that has passed through the ink permeation layer, and a supporting and protective layer which is positioned on the opposite side of the ink permeation layer with the image receiving layer sandwiched therebetween, supports the ink permeation layer and the image receiving layer, and protects the image receiving layer and the ink permeation layer.

In the transfer film, the ink permeation layer also functions as a pressure sensitive adhesive layer for heating and adhering the transfer film to the printing material. In addition, in a preferable aspect of this transfer film, the supporting and protective layer is divided into a protective layer which protects the ink permeation layer and the image receiving layer, and a support which supports the ink permeation layer and the image receiving layer.

In a case where printing is performed on the printing material using the transfer film described in JP5864160B, printing is performed on the transfer film from the jetting surface of the ink permeation layer by an ink jet method and the printed image is received and held in the image receiving layer. Next, by causing the jetting surface of the ink permeation layer to abut on the printing material and heating the transfer film, the transfer film (ink permeation layer) and the printing material are heated and adhered to each other.

Finally, a laminate including the ink permeation layer, the image receiving layer, and the protective layer is transferred to the printing material by peeling off the support from the transfer film, and thus an image is formed on the printing material by the ink jet method (refer to FIG. 6).

### SUMMARY OF THE INVENTION

According to the transfer film described in JP5864160B, printing is performed on the sheet-like transfer film by an ink jet method in advance, then the transfer film is heated and adhered to the printing material, and the support is peeled off. Thus, an image is formed on the printing material by ink jet. Therefore, regardless of the shape of the printing material, printing can be performed by the same printing method as a usual ink jet method for an ink jet image receiving paper or the like.

In addition, since this transfer film has an ink permeation layer different from the image receiving layer and the transfer film (the laminate including the ink permeation layer, the image receiving layer, and the protective layer) is adhered to the printing material by this ink permeation layer, the image receiving layer which holds the image is not affected by adhesion. Therefore, a high quality image can be formed on the printing material.

However, not only in the transfer film described in JP5864160B, but also in a transfer film, which has a support, a protective layer, an image receiving layer, and an ink permeation layer, is adhered to a printing material after printing is performed by an ink jet method, and is then peeled off from the support, there arise problems such that the support cannot be peeled off due to poor peelability between the support and the protective layer, the image receiving layer is peeled off from the supporting and the protective layer due to poor adhesion between the protective layer and the image receiving layer, or the protective layer is not formed on the image receiving layer due to the cohesively broken image receiving layer, and the laminate including the ink permeation layer, the image receiving layer, and the protective layer transferred by peeling off the support reaches the outside of the printing material, and thus the transfer to the printing material cannot be appropriately performed in many cases.

In addition, in the laminate including the ink permeation layer, the image receiving layer, and the protective layer adhered to the printing material, it is preferable that the protective layer which protects the image receiving layer has excellent scratch resistance so that the image held by the image receiving layer can be observed clearly. However, in a transfer film of the related art, the scratch resistance of the protective layer is not sufficient in many cases.

Therefore, in such a transfer film, the appearance of a transfer film excellent in peelability of the support and scratch resistance of the protective layer is desired.

The object of the present invention is to solve such problems in the related art and is to provide a transfer film in which a support can be appropriately peeled off after printing is performed by an ink jet method and the transfer film is adhered to a printing material, and the scratch resistance of a protective layer is excellent, and an image forming method using this transfer film.

In order to achieve the object, the present invention provides a transfer film comprising: a support; a protective layer that is formed on one surface of the support; an image receiving layer that is formed on a surface of the protective layer; and an ink permeation layer that is formed on a surface of the image receiving layer and has voids for allowing permeation of an ink,

in which the protective layer has a thickness of 5 μm or less and contains a polymer having a glass transition temperature of 0° C. or higher.

In such a transfer film according to the present invention, it is preferable that a glass transition temperature of the polymer having a glass transition temperature of 0° C. or higher is 20° C. to 80° C.

It is preferable that a solubility parameter of the polymer having a glass transition temperature of 0° C. or higher is 8.5 (cal/cm³)^{1/2} or more.

In addition, it is preferable that the protective layer contains two or more kinds of the polymers having a glass transition temperature of 0° C. or higher.

Further, it is preferable that the polymer having a glass transition temperature of 0° C. or higher is a urethane-based polymer.

The present invention also provides an image forming method comprising: a printing step of performing printing on the transfer film according to the present invention from the ink permeation layer by an ink jet method;

an adhering step of causing the ink permeation layer of the transfer film subjected to printing to abut on a printing material and heating and adhering the transfer film and the printing material; and

a peeling step of peeling off the support from the transfer film adhered to the printing material.

In such an image forming method, it is preferable that the transfer film is long, and the adhering step and the peeling step are performed while the long transfer film and the printing material are being transported in a longitudinal direction of the long transfer film at a same speed.

In addition, it is preferable that a transport path of the long transfer film has an approaching region which is directed in a direction in which the transfer film approaches the printing material, and a separating region which is provided on a downstream side of the approaching region and is directed in a direction in which the transfer film is separated from the printing material, the adhering step is performed between the approaching region and the separating region, and the peeling step is performed in the separating region.

In addition, it is preferable that the printing step is performed while the long transfer film is being transported in the longitudinal direction on an upstream side of a region where the adhering step is performed in a transport direction of the long transfer film.

Further, it is preferable that the printing material has a card shape.

According to the present invention, it is possible to realize a transfer film in which a support can be appropriately peeled off after printing is performed by an ink jet method and the transfer film is adhered to a printing material, and the scratch resistance of a protective layer is excellent, and an image forming method capable of forming a high quality image on an arbitrary printing material using this transfer film.

### BRIEF DESCRIPTION OF THE DRAWINGS

FIG. 1 is a view conceptually showing an example of a transfer film according to the present invention.

FIG. 2 is a view conceptually showing an image receiving layer of the transfer film shown in FIG. 1.

FIG. 3 is a view conceptually showing an ink permeation layer of the transfer film shown in FIG. 1.

FIG. 4 is a view conceptually showing an example of an image forming apparatus for carrying out an image forming method according to the present invention.

FIG. 5 is a view conceptually showing another example of the image forming apparatus for carrying out the image forming method according to the present invention.

FIG. 6 is a view conceptually showing image formation using a transfer film of the related art.

FIG. 7 is a view conceptually showing image formation using the transfer film of the related art.

### DESCRIPTION OF THE PREFERRED EMBODIMENTS

Hereinafter, a transfer film and an image forming method according to suitable embodiments of the present invention will be described in detail based on the attached drawings.

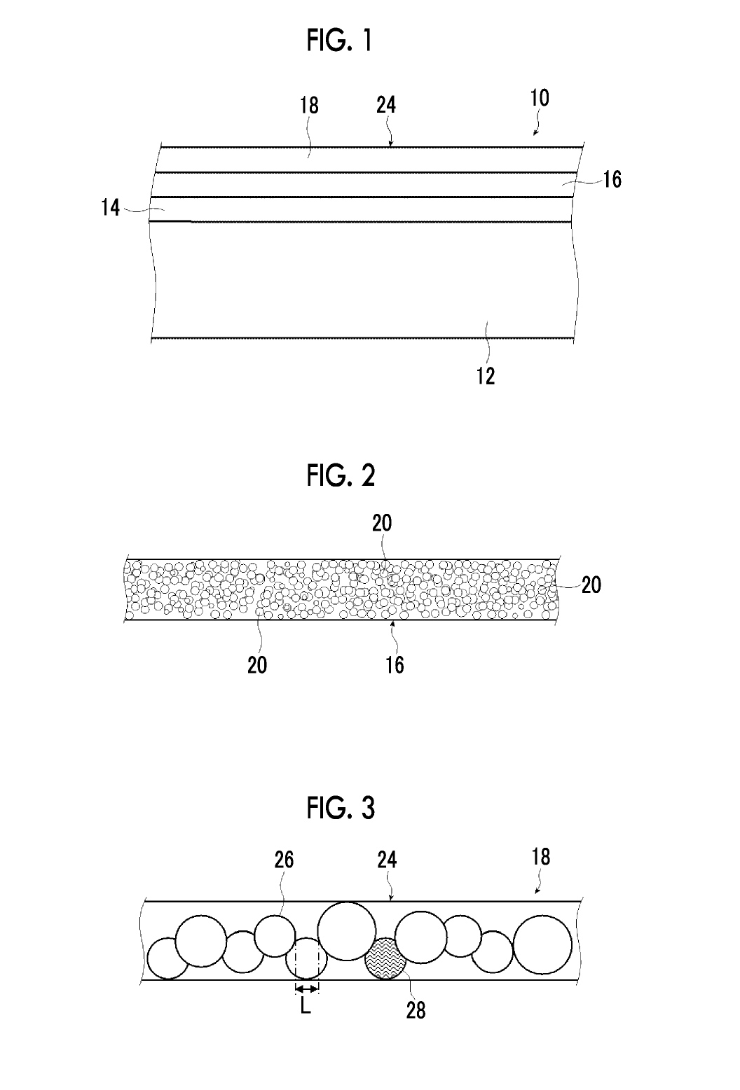

FIG. 1 is a view conceptually showing an example of a transfer film according to an embodiment of the present invention.

As shown in FIG. 1, a transfer film 10 according to an embodiment of the present invention has a support 12, a protective layer 14 that is formed on one surface of the support 12, an image receiving layer 16 that is formed on a surface of the protective layer 14, and an ink permeation layer 18 that is formed on a surface of the image receiving layer 16.

Although described in detail later, after printing is performed on the transfer film from the ink permeation layer 18 by an ink jet method, the transfer film 10 is adhered to the printing material P by heating and adhering the ink permeation layer 18 to an article which becomes a printing material P, and then the support 12 is peeled off from the protective layer 14. Thus, a laminate including the ink permeation layer 18, the image receiving layer 16, and the protective layer 14 is transferred to the printing material P and an image is formed on the article which becomes a printing material P.

Accordingly, in a state in which the laminate including the ink permeation layer 18, the image receiving layer 16, and the protective layer 14 is transferred to the printing material P, the protective layer 14 becomes a surface and the ink permeation layer 18 becomes a layer close to the printing material P.

The support 12 supports the protective layer 14, the image receiving layer 16, and the ink permeation layer 18 until the transfer film 10 is adhered to the printing material P.

For the support 12, various sheet materials (films) can be used as long as the material can support the protective layer 14, the image receiving layer 16, and the ink permeation layer 18, and has sufficient heat resistance with respect to heating and adhesion of the printing material P, which will be described later, and the ink permeation layer 18.

Examples of the support 12 include resin films formed of various resin materials. Specific examples of the resin materials used to form the support 12 include polyester resins such as polyethylene terephthalate (PET) and polyethylene naphthalate (PEN), polycarbonate resins, (meth)acrylic resins, and polyimide resins.

The thickness of the support 12 is not particularly limited and the thickness at which the protective layer 14, the image receiving layer 16, and the ink permeation layer 18 can be supported until the printing material P, which will be described later, and the ink permeation layer 18 are heated and adhered to each other and peeling can be appropriately performed without causing breakage after the transfer film 10 is adhered to the printing material P, may be appropriately set according to the forming material or the like.

The thickness of the support 12 is preferably 20 to 200 μm and more preferably 50 to 130 μm.

The protective layer 14 is formed on one surface of the support 12.

The protective layer 14 is a layer which protects the image receiving layer 16 holding an image formed by an ink jet method after the transfer film 10 is adhered to the printing material P and the support 12 is peeled off.

Here, in the transfer film 10 according to the embodiment of the present invention, the protective layer 14 is a layer having a thickness of 5 μm or less and containing a polymer having a glass transition temperature (Tg) of 0° C. or higher.

Since the transfer film 10 according to the embodiment of the present invention has such a protective layer 14, the peelability between the support 12 and the protective layer 14 and the scratch resistance of the protective layer 14 can be improved and further, the transfer of the unnecessary laminate of the ink permeation layer 18, the image receiving layer 16, and the protective layer 14, which is larger than the printing material P, to the printing material P can be suppressed.

As described above, as a transfer film which makes printing possible with an ink jet method using an article of an arbitrary shape as a printing material, as disclosed in JP5864160B, a transfer film formed by laminating a support, a protective layer, an image receiving layer, and an ink permeation layer is known.

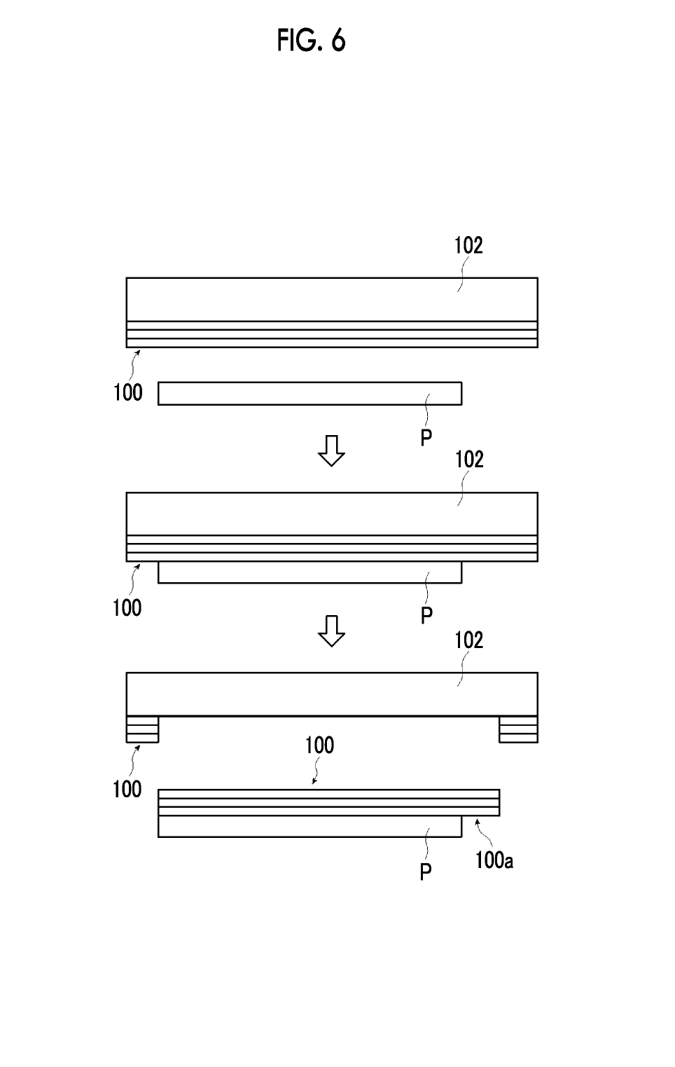

As described above, after printing is performed on the transfer film from the ink permeation layer by an ink jet method, as conceptually shown in FIG. 6, the transfer film (ink permeation layer) and the printing material P are heated and adhered to each other and a support 102 is peeled off from the protective layer so that a laminate 100 including the ink permeation layer, the image receiving layer, and the protective layer is transferred to the printing material P to form an image on the printing material P by the ink jet method.

However, in the transfer film of the related art, there arise problems such that transferability is not sufficient, the support 102 cannot be peeled off due to poor peelability between the support 102 and the protective layer, the image receiving layer is peeled off from the support and protective layer due to poor adhesion between the protective layer and the image receiving layer, or the protective layer is not formed on the image receiving layer due to poor adhesion between the protective layer and the image receiving layer and the cohesively broken image receiving layer, and as conceptually shown by reference numeral 100a in the lower side of FIG. 6, the unnecessary laminate 100 is transferred to the outside of the printing material P, and thus the transfer to the printing material P cannot be appropriately performed in many cases. In the following description, the transfer of the unnecessary laminate 100 indicated by reference numeral 100a is also referred to as “wing attachment 100a” for the sake of convenience.

In addition, in the transfer film of the related art, the scratch resistance of the protective layer which becomes the outermost layer after transfer is not sufficient and the protective layer is easily damaged by contact with other articles. Thus, the visibility of an image is deteriorated.

In contrast, since the protective layer 14 contains a polymer having a glass transition temperature of 0° C. or higher and has a thickness of 5 μm or less in the transfer film 10 according to the embodiment of the present invention, the laminate of the ink permeation layer 18, the image receiving layer 16, and the protective layer 14, which has the protective layer 14 having excellent scratch resistance, can be transferred to the printing material P without causing transfer of the protective layer 14 to the support 12, formation of the wing attachment 100a, and the like.

Further, although described later, the transfer film according to the embodiment of the present invention makes it possible to form an image having excellent surface glossiness and high quality on the printing material P.

In general, it is known that the adhesiveness between the resin film which becomes the support and a layer to be formed thereon which is formed of a polymer becomes stronger as the solubility parameters of each material constituting the resin film and the layer formed of a polymer become closer to each other.

However, according to the study of the present inventors, by increasing the glass transition temperature of the polymer contained in the protective layer 14 to be formed on the surface of the support 12, regardless of the solubility parameter of the polymer, the peelability between the support 12 and the protective layer 14 can be improved. In particular, the tendency becomes stronger in a case where the protective layer 14 is formed of a latex-based material.

That is, since the protective layer 14 contains a polymer having a glass transition temperature of 0° C. or higher, the peelability between the support 12 and the protective layer 14 after heating and adhesion is improved in the transfer film 10 according to the embodiment of the present invention, defects such that the support 12 cannot be appropriately peeled off, and the wing attachment 100a is formed as shown in FIG. 6 are prevented, and thus the support 12 can be appropriately peeled off from the protective layer 14. In addition, since the protective layer 14 contains a polymer having a glass transition temperature of 0° C. or higher, the scratch resistance of the protective layer 14 can be increased.

The glass transition temperature of the polymer contained in the protective layer 14 is preferably 20° C. or higher and more preferably 30° C. or higher.

The upper limit of the glass transition temperature of the polymer having a glass transition temperature of 0° C. or higher is not particularly limited. Here, according to the study of the present inventors, the glass transition temperature of the polymer contained in the protective layer 14 is preferably 80° C. or lower.

By setting the glass transition temperature of the polymer contained in the protective layer 14 to 80° C. or lower, the formation of the protective layer 14 (film formation) can be suitably performed and the film forming temperature can be lowered. Thus, it is preferable to set the glass transition temperature to 80° C. or lower from the viewpoint that the selection range of the support 12 can be widened.

The glass transition temperature of the polymer may be measured by a known method or numerical values described in various documents may be used. In a case of using a commercially available polymer, a numerical value described in a catalog or the like may be used or a numerical value calculated from the composition of a polymer may be used. For example, as a method of measuring the glass transition temperature, a measurement method according to Japanese industrial standards (JIS) K 7121 using a differential scanning calorimetry may be used.

The solubility parameter (SP value) of the polymer having a glass transition temperature of 0° C. or higher contained in the protective layer 14 is preferably 8.5 (cal/cm³)^{1/2} or greater and more preferably 9.0 (cal/cm³)^{1/2} or greater.

By setting the solubility parameter of the polymer contained in the protective layer 14 to 8.5 (cal/cm³)^{1/2} or greater, the protective layer can be formed of a polymer having high polarity and a strong cohesive force. Thus, from the viewpoint that the scratch resistance of the protective layer 14 can be improved, the tensile strength of the protective layer 14 is high, and the peelability can be improved, it is preferable to set the solubility parameter to 8.5 (cal/cm³)^{1/2} or greater.

The solubility parameter of the polymer may be measured by a known method or and numerical values described in various documents may be used. In a case of using a commercially available polymer, a numerical value described in a catalog or the like may be used.

In addition, the SI unit of the solubility parameter is [(MPa)^{1/2}]. The unit [(cal/cm³)^{1/2}] can be converted to [(MPa)^{1/2}] which is the SI unit by multiplying by 2.05. That is, it is “[(MPa)^{1/2}]=[(cal/cm³)^{1/2}]×2.05”.

In addition, in the present invention, the thickness of the protective layer 14 is 5 μm or less.

Image formation is performed on the printing material P using the transfer film 10 according to the embodiment of the present invention by, in a state in which the ink permeation layer 18 of the transfer film 10 and the printing material P are caused to abut each other, heating and adhering the ink permeation layer 18 and the printing material P and then peeling off the support 12, as described above.

In this case, in order to appropriately transfer the laminate including the ink permeation layer 18, the image receiving layer 16, and the protective layer 14 to the printing material P, in a case where the support 12 is peeled off, it is necessary to break the laminate including the ink permeation layer 18, the image receiving layer 16, and the protective layer 14. This breakage is performed by using the pressure sensitive adhesive force between the ink permeation layer 18 and the printing material P.

Here, in a case where the protective layer 14 is thick, the laminate including the ink permeation layer 18, the image receiving layer 16, and the protective layer 14 cannot be appropriately broken, the laminate adhered to the printing material P pulls the laminate in a region not adhered to the printing material P outside the printing material P, and the laminate outside the printing material P is also transferred to the printing material P. Thus, the wing attachment 100a as shown in FIG. 6 described above is formed.

In contrast, in the transfer film 10 according to the embodiment of the present invention, by setting the thickness of the protective layer 14 to 5 μm or less, the laminate including the ink permeation layer 18, the image receiving layer 16, and the protective layer 14 can be appropriately broken at the end portion of the printing material P by using the pressure sensitive adhesive force between the ink permeation layer 18 and the printing material P. As a result, it is possible to appropriately transfer the laminate including the ink permeation layer 18, the image receiving layer 16, and the protective layer 14 to the printing material P without forming the wing attachment 100a as shown in FIG. 6 described above.

In other words, in the present invention, by setting the thickness of the protective layer 14 to 5 μm or less, the laminate transfer film including the ink permeation layer 18, the image receiving layer 16, and the protective layer 14 can be transferred to the printing material P without using a step of cutting the transfer film 10 after transfer or the like.

The thickness of the protective layer 14 is preferably 4 μm or less and more preferably 3 μm or less.

The lower limit of the thickness of the protective layer 14 is not particularly limited and the thickness at which the image receiving layer 16 can be sufficiently protected may be appropriately set according to the forming material of the protective layer 14.

The thickness of the protective layer 14 is preferably 1 μm or more and more preferably 2 μm or more. The protective layer 14 may have a single layer structure or a multilayer structure.

In the transfer film 10 according to the embodiment of the present invention, as the polymer contained in the protective layer 14, known various polymers can be used as long as the polymer has a glass transition temperature of 0° C. or higher.

Examples thereof include a urethane-based polymer, an acrylic polymer, a vinyl acetate-based polymer, a vinyl chloride-based polymer, a rubber-based polymer, a styrene-based polymer, a silicone-based polymer, an ester-based polymer, an amide-based polymer or a copolymer including a plurality of repeating units constituting these polymers. Among these, from the viewpoint of further excellent peelability of the support, a urethane-based polymer is preferable.

In addition, as the polymer having a glass transition temperature of 0° C. or higher, a commercially available product may be used.

Examples of the commercially available product include SUPER FLEX 170 (urethane-based polymer), SUPER FLEX 820 (urethane-based polymer), SUPER FLEX 830HS (urethane-based polymer), and SUPER FLEX 870 (urethane-based polymer) manufactured by Dai-Ichi Kogyo Seiyaku Co., Ltd.;

VINYBLAN 287 (vinyl chloride-acrylic polymer), VINYBLAN 900 (vinyl chloride-acrylic polymer), VINYBLAN 2684 (acrylic polymer), VINYBLAN 2685 (acrylic polymer), VINYBLAN 2687 (acrylic polymer), and VINYBLAN 715S (vinyl chloride-based polymer) manufactured by Nissin Chemical Industry Co., Ltd.;

SUMIKAFLEX 752HQ (ethylene-vinyl acetate copolymer resin emulsion), SUMIKAFLEX 808HQ (ethylene-vinyl acetate-vinyl chloride copolymer resin emulsion), SUMIKAFLEX 850HQ (ethylene-vinyl acetate-vinyl chloride copolymer resin emulsion), and SUMIKAFLEX 830 (ethylene-vinyl acetate-vinyl chloride copolymer resin emulsion) manufactured by Sumika Chemitex Co., Ltd.;

Nipol LX433C (styrene butadiene rubber), Nipol LX2507H (styrene butadiene rubber), Nipol LX416 (styrene butadiene rubber), Nipol LX814 (acrylic polymer), and Nipol LX855EX1 (acrylic polymer) manufactured by Zeon Corporation; and

MOWINYL 742A (acrylic polymer), MOWINYL 1711 (acrylic polymer), MOWINYL 6520 (acrylic polymer), MOWINYL 7980 (acrylic polymer), MOWINYL 081F (vinyl acetate-ethylene-based copolymer), and MOWINYL 082 (vinyl acetate-ethylene-based copolymer) manufactured by The Nippon Synthetic Chemical Industry Co., Ltd.

A plurality of these polymers having a glass transition temperature of 0° C. or higher may be used in combination. That is, the protective layer 14 may contain two or more polymers having a glass transition temperature of 0° C. or higher.

Since the protective layer 14 contains two or more polymers, it is possible to obtain the transfer film 10 in which the transferability and scratch resistance of the protective layer is excellent by expressing the properties of the respective polymers. For example, by using a urethane-based polymer and an ethylene-vinyl acetate-vinyl chloride copolymer in combination, it is possible to obtain the transfer film 10 in which the peelability of the support 12 and the scratch resistance of the protective layer 14 are excellent.

The content of the polymer having a glass transition temperature of 0° C. or higher in the protective layer 14 is preferably 20% by mass or more, more preferably 30% by mass or more, and particularly preferably 50% by mass or more.

It is preferable to set the content of the polymer having a glass transition temperature of 0° C. or higher in the protective layer 14 to 20% by mass or more from the viewpoint that the peelability between the support 12 and the protective layer 14 can be improved, the scratch resistance of the protective layer 14 can be improved, and the bendability (flexibility) can be improved.

The protective layer 14 may contain a surfactant, if necessary.

The protective layer contains a surfactant and thus the peelability between the support 12 and the protective layer 14 can be improved.

Examples of the surfactant include non-ionic surfactants such as ethers such as polyoxyethylene nonyl phenyl ether, polyoxyethylene octyl phenyl ether, polyoxyethylene dodecyl phenyl ether, polyoxyethylene oleyl ether, polyoxyethylene lauryl ethers, and polyoxyalkylene alkyl ethers (for example, EMULGEN series such as EMULGEN 108, 109P, and the like, manufactured by Kao Corporation, SOFTANOL EP-5035, 7085, and 9050, manufactured by NIPPON SHOKUBAI Co., Ltd., and PLURONIC L-31, L-34, and L-44 manufactured by ADEKA Corporation);

esters such as polyoxyethylene oleate, polyoxyethylene distearate, sorbitan laurate, sorbitan monostearate, sorbitan monooleate, sorbitan sesquioleate, polyoxyethylene monooleate, and polyoxyethylene stearate; and

polyglycol ethers such as polyoxyethylene acetylene glycol ether, polyoxyethylene distyrenated phenyl ether, and polyoxyethylene tribenzylated phenyl ether (for example, SURFYNOL 104, 104PG50, 105PG50, 82, 420, 440, 465, and 485, and OLFINE STG, manufactured by Nissin Chemical Industry Co., Ltd.), and various known surfactants can be used according to the forming material of the protective layer 14. In addition, as the surfactant, a commercially available product may be used.

The content of the surfactant in the protective layer 14 is preferably 0.01% to 5% by mass and more preferably 0.1% to 2% by mass.

Further, if necessary, the protective layer 14 may contain various additives such as a wax, an inorganic pigment, an ultraviolet absorber, an antioxidant, and the like other than the surfactant.

The image receiving layer 16 is formed on the surface of the protective layer 14. The image receiving layer 16 is a layer for holding an image by jetting an ink by an ink jet method and absorbing and fixing the ink permeated into the ink permeation layer 18.

The image receiving layer 16 is a layer formed of a polymer capable of receiving and swelling an aqueous ink, or a layer having voids (micropores) in which fine particles of an ink insoluble in a solvent (dispersion medium) are fixed by a binder. The aqueous ink is an ink containing water and/or a solvent soluble in water as a main component.

FIG. 2 is a view conceptually showing an example of the configuration of the image receiving layer 16.

The image receiving layer 16 shown in FIG. 2 is formed by fixing a plurality of ink receiving particles 20 insoluble in an ink by a binder and the ink is received in each gap of the ink receiving particles 20.

For the ink receiving particles 20, ink receiving particles which do not cause aggregation with a fixing agent for fixing a coloring material in an ink between the ink receiving particles 20 can be selected, and for example, ink receiving particles with nonpolarity or low polarity are selected. For example, as the ink receiving particles 20, polymer fine particles such as polyolefin, acryl, polystyrene, and polyester fine particles, and inorganic fine particles such as calcium carbonate, kaolin, aluminum silicate, calcium silicate, colloidal silica, alumina, and aluminum hydroxide fine particles can be used.

On the other hand, as a binder for fixing the ink receiving particles 20, gelatin, polyvinyl alcohol, polyvinyl pyrrolidone, alginic acid, aqueous polyester, and a water-soluble polymer such as an aqueous acrylic resin can be used.

In a case where the image receiving layer 16 for holding the coloring material in the ink has an own optical scattering function, the coloring intensity of the coloring material is lowered, and thus an image with low contrast is formed. Therefore, it is preferable that the image receiving layer 16 transparent without causing light scattering.

In consideration of this point, in order to suppress light scattering and light absorption and make the image receiving layer 16 transparent, as the ink receiving particles 20, it is preferable to use ink receiving particles which are colorless and has a particle size smaller than the wavelength of visible light or which is colorless and has a refractive index difference with the binder for fixing the ink receiving particles 20 of 0.1 or less. As a combination in which the refractive index difference between the ink receiving particles 20 and the binder is 0.1 or less, for example, a combination in which silica is used as the ink receiving particles 20 and polyvinyl alcohol (PVA) is used as the binder is exemplified.

It is preferable that the image receiving layer 16 fixes the coloring material of the ink to the surfaces of the ink receiving particles 20 so as not to be moved.

Therefore, it is preferable that the surfaces of the ink receiving particles 20 is treated to have a polarity opposite to the polarity of the coloring material of the ink. For example, by forming a fixing agent having a polarity opposite to the polarity of the coloring material of the ink to form the image receiving layer 16, the image receiving layer 16 can be charged to a polarity opposite to the polarity of the ink.

As such a fixing agent, in a case where the ink contains an anionic coloring material, a fixing agent having a primary amino group a secondary amino group, a tertiary amino group, or a quaternary ammonium group, such as dicyandiamide, diethylenetriamine, dimethylamine and diallyldimethylammonium chloride having a cationic polarity, can be used. On the other hand, in a case where the ink contains a cationic coloring material, an anionic fixing agent, for example, a water-soluble polymer or water dispersible polymer having a structure having carboxylic acid, sulfonic acid, phosphoric acid, or the like, as a hydrophilic group, can be used. As a fixing agent having such a structure, specifically, sodium salts such as animal and vegetable fat and fatty acid, alkylbenzene sulfonic acid, and alkyl naphthalene sulfonic acid, potassium salts and the like are exemplified.

The thickness of the image receiving layer 16 is not particularly limited and the thickness at which an image formed by jetting an ink by an ink jet method can be appropriately held may be appropriately set according to the forming material of the image receiving layer 16 such as the ink receiving particles 20.

The thickness of the image receiving layer 16 is preferably 5 to 50 μm and more preferably 10 to 40 μm. The image receiving layer 16 may have a single layer structure or a multilayer structure.

On the surface of the image receiving layer 16, the ink permeation layer 18 is provided.

The ink permeation layer 18 is a layer having a jetting surface 24 on which an ink is jetted to the surface by an ink jet method and voids for allowing permeation of the jetted ink to reach the image receiving layer 16. In addition, after printing is performed on the transfer film 10, the ink permeation layer 18 functions as a pressure sensitive adhesive layer (adhesive layer or pressure sensitive adhesive layer) for heating and adhering the transfer film 10 to the printing material P.

FIG. 3 conceptually shows the configuration of the ink permeation layer 18.

In the ink permeation layer 18 shown in FIG. 3, the voids for allowing permeation of the ink are formed by gaps L of a plurality of thermoplastic resin particles 26 which are dispersed over the entire layer. Each gap L formed by the thermoplastic resin particles 26 is formed continuously in a thickness direction and thus the voids penetrating the ink permeation layer 18 in the thickness direction are formed. In the ink permeation layer 18, the ink jetted to the jetting surface 24 passes through the voids penetrating the ink permeation layer in the thickness direction and thus the ink passes through the ink permeation layer 18 and supplied to the image receiving layer 16.

In the ink permeation layer 18, it is preferable that the gap L (inter-particle distance) between the thermoplastic resin particles 26 is controlled to be 0.1 μm or more by selecting the particle size and particle distribution of the thermoplastic resin particles 26 or the like not to prevent permeation of the ink.

In addition, in the ink permeation layer 18, it is preferable that the particle size of the thermoplastic resin particle 26 is 0.1 to 10 μm so as not to prevent permeation of the ink and not to diffuse the ink in a direction parallel with the principal surface of the transfer film 10.

Further, the thermoplastic resin particles 26 is preferably formed of a material having a softening temperature of 40° C. to 100° C. so as not to prevent permeation of the ink at environmental temperature such as room temperature while the transfer film 10 is thermally bonded to the printing material P.

As such a material, for example, a styrene copolymer resin of styrene, acryl, and butadiene, or the like, a polyolefin-based resin, a resin formed of polymethacrylic acid and a derivative thereof, an acrylic ester-based resin, a polyacrylamide-based resin, a polyester-based resin, and a polyamide-based resin can be used.

The ink permeation layer 18 is preferably charged to the same polarity as the polarity of the ink so as to promote permeation of the ink in the voids. For example, by dispersing the thermoplastic resin particles 26 forming the voids using a charge control agent having the same polarity as the polarity of the coloring material in the ink, the ink permeation layer 18 can be charged to the same polarity as the polarity of the ink.

As the charge control agent, in a case where the ink contains an anionic coloring material such as an acidic dye, and in a case where the ink has a pigment dispersion that is charged with an anionic surfactant, a charge control agent with an anionic polarity is used. That is, as the anionic charge control agent, an anionic charge control agent of which the ions become negative ions when dissociated in water is used and for example, those having a carboxylic acid, sulfonic acid, or a phosphoric acid structure as a hydrophilic group are used. Specifically, as a carboxylic acid-based charge control agent, a fatty acid salt included soap as a main component, cholate, or the like can be used, as a sulfonic acid-based charge control agent, linear sodium alkylbenzene sulfonate, sodium lauryl sulfate, monoalkyl sulfate, alkyl polyoxyethylene sulfate, or the like can be used, and as a charge control agent having a phosphoric acid structure, monoalkyl phosphate or the like can be used.

On the other hand, in a case where the ink contains a cationic coloring material such as an alkaline dye, a cationic charge control agent is used. That is, as the cationic charge control agent, a cationic charge control agent of which the ions become positive ions when dissociated in water is used, and for example, those having tetraalkylammonium as a hydrophilic group are used. Specifically, an alkyltrimethylammonium salt, dialkyldimethylammonium salt, an alkylbenzyldimethylammonium salt and the like can be used.

Further, it is preferable that in the ink permeation layer 18, tackifier particles 28 (tackifying resin particles 28) for improving adhesion to the printing material P are included in a dispersed manner.

As the material constituting the tackifier particles 28, rosins, rosin esters, alicyclic resins, phenol resins, chlorinated polyolefin resins and the like can be used. Incidentally, the tackifier can also be contained inside the thermoplastic resin particles 26 without being dispersed in the ink permeation layer 18 as particles. By incorporating the tackifier into the thermoplastic resin at the time of thermal transfer, it is possible to strengthen the adhesion with the printing material.

As described above, the ink permeation layer 18 is disposed closer to the printing material P than to the image receiving layer 16 which carries the image in a state in which the transfer film 10 is transferred to the printing material P. That is, in a case where the image formed on the printing material P by the transfer film 10 is appreciated, the ink permeation layer 18 becomes an underlayer of the image receiving layer 16 which holds the image.

Therefore, for example, the ink permeation layer 18 may be formed as a white layer or light scattering layer by mixing organic resin fine particles formed of a white inorganic pigment, white polycarbonate, and a (meth)acrylic resin, light scattering particles, or the like with the ink permeation layer 18. Thus, regardless of the color of the printing material P to which the transfer film 10 is transferred, the visibility and sharpness of the image by the ink can be improved.

The thickness of the ink permeation layer 18 is not particularly limited and the thickness which allows the ink jetted by the ink jet method to appropriately permeate into the image receiving layer 16 and allows heating and adhesion with the printing material P with sufficient adhesion may be appropriately set according to the forming material of the ink permeation layer 18 such as the thermoplastic resin particles 26 or the like.

The thickness of the ink permeation layer 18 is preferably 0.5 to 5 μm and more preferably 0.8 to 3 μm. The ink permeation layer 18 may have a single layer structure or a multilayer structure.

Such a transfer film 10 according to the embodiment of the present invention can be prepared by a known method according to the forming material of each layer.

As an example, a resin film which becomes the support 12 is prepared.

On the other hand, a coating liquid for forming a protective layer 14 obtained by dissolving or dispersing a compound, which becomes the protective layer 14, such as a polymer having a glass transition temperature of 0° C. or higher or the like, in ion exchange water or the like is prepared. In addition, a coating liquid for forming an image receiving layer 16 obtained by dissolving or dispersing a compound, which becomes the image receiving layer 16, such as the ink receiving particles 20 such as silica particles, and a binder, in ion exchange water or the like, is prepared. Further, a coating liquid for forming a ink permeation layer 18 obtained by dissolving or dispersing a compound, which becomes the ink permeation layer 18, such as the thermoplastic resin particles 26 such as polyethylene particles, a binder, or the like, in ion exchange water or the like, is prepared.

Additionally, first, the coating liquid for forming a protective layer 14 is applied to the surface of the support 12 and is dried to form the protective layer 14. The coating liquid may be applied by a known method such as a bar coating method, a die coating method, and dipping (dip coating). In addition, the coating liquid may be dried by a known method according to the coating liquid such as heating and drying using hot air or a heater. In this regard, both the image receiving layer 16 and the ink permeation layer 18 are similar.

Next, the coating liquid for forming an image receiving layer 16 is applied to the surface of the formed protective layer 14 and dried to form the image receiving layer 16.

Further, the coating liquid for forming an ink permeation layer 18 is applied to the surface of the formed image receiving layer 16 and dried and the ink permeation layer 18 is formed. Thus, the transfer film 10 is prepared.

An image forming method according to an embodiment of the present invention is provided for forming an image by an ink jet method on an article such as the printing material P using such a transfer film 10 according to the embodiment of the present invention.

In the image forming method according to the embodiment of the present invention, the printing material P is not particularly limited and various recording media such as a CD and a DVD, and various known articles such as a resin molded article, a metal product, and a product formed of paper such as coated cardboard or corrugated board can be used. Among these, a card-like material such as a ride card for a train, a bus, and the like, a credit card, an electronic money card, an identification (ID) card, a card key, and various point cards are suitably used as the printing material P.

In the image forming method according to the embodiment of the present invention, first, printing is performed from the jetting surface 24 of the ink permeation layer 18 of the transfer film 10 by an ink jet method (printing step). The ink jetted to the jetting surface 24 of the ink permeation layer 18 permeates into the ink permeation layer 18 by passing through the gaps of the thermoplastic resin particles 26 and reaches the image receiving layer 16, and the image formed by the ink is held in the image receiving layer 16.

After printing is performed on the transfer film 10 by the ink jet method, in the same manner as shown in FIG. 6 described above, the ink permeation layer 18 is caused to abut on an article which becomes the printing material P, and the printing material P and the transfer film 10 are laminated. Next, if necessary, while pressing the printing material P and the transfer film 10, for example, by heating from the support 12, the transfer film 10 (ink permeation layer 18) and the printing material P are heated and adhered to each other (heating bonding or heating adhesion) (adhering step).

After the transfer film 10 and the printing material P are adhered, the support 12 is peeled off from the transfer film 10 and the laminate including the ink permeation layer 18, the image receiving layer 16, and the protective layer 14 is transferred to the printing material P to form an image printed on the printing material P by the ink jet method.

As described above, in the transfer film 10 according to the embodiment of the present invention, the protective layer 14 is a layer containing a polymer having a glass transition temperature of 0° C. or higher and having a thickness of 5 μm or less. Therefore, according to the image forming method according to according to the embodiment of the present invention using the transfer film 10 according to the embodiment of the present invention, after the transfer film 10 is adhered to the printing material P, the support 12 can be peeled off from the protective layer 14 with good peelability and an image can be formed on the printing material P by the ink jet method by transferring the laminate including the ink permeation layer 18, the image receiving layer 16, and the protective layer 14 to only the surface of the printing material P without forming the wing attachment 100a.

Here, in the image forming method according to the embodiment of the present invention, for example, as shown in FIG. 6, an image may be formed on the printing material P using the transfer film in a cut-sheet form. However, preferably, a long transfer film is used and an image is formed on the printing material P by the transfer film, while moving the transfer film and the printing material P in the longitudinal direction of the transfer film at the same speed.

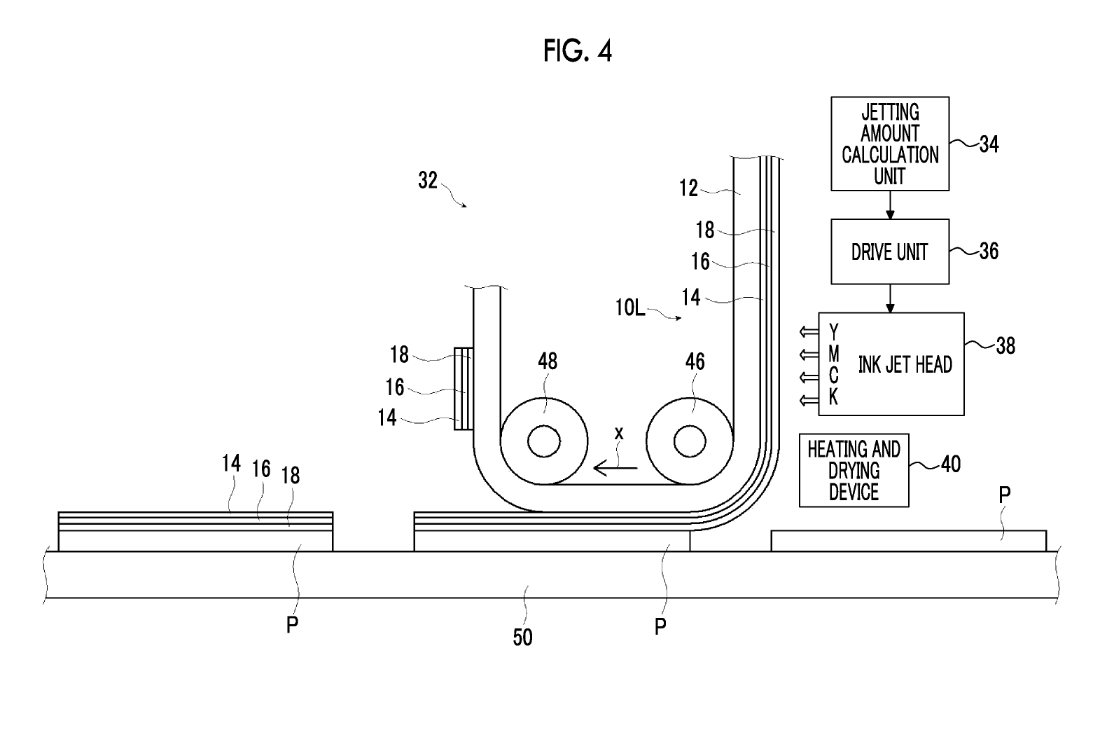

FIG. 4 is a view conceptually showing an example of an image forming apparatus for carrying out an image forming method using such a long transfer film.

An image forming apparatus 32 shown in FIG. 4 is provided for forming an image on a card-like printing material P using a long transfer film 10L.

The image forming apparatus 32 has a jetting amount calculation unit 34, a drive unit 36, an ink jet head 38, a heating and drying device 40, a heating roller 46, a peeling roller 48, and moving means 50.

The image forming apparatus 32 adopts a so-called roll-to-roll method. That is, the long transfer film 10L is sent out from a film roll (not shown) formed by winding the transfer film 10L into a roll shape, while being transported in the longitudinal direction by a predetermined transport path passing through the heating roller 46 and the peeling roller 48, the transfer film is subjected to printing and transfer to the printing material P (image formation), and then the support 12 is wound onto a collecting roll (not shown) in a roll shape.

In addition to the support 12, the ink permeation layer 18, the image receiving layer 16, and the protective layer 14 (that is, the transfer film), which are not subjected to transfer, are partially wound onto the collecting roll.

The width of the transfer film 10L may be the same as the size of the printing material P, may be larger than the size of the printing material P, or may be smaller than the size of the printing material P.

On the other hand, the printing material P is placed on the moving means 50 and is transported in synchronization with the transport of the transfer film 10L in the transport direction of the transfer film 10L (in the direction of the arrow x in the drawing), that is, in the direction the same as the longitudinal direction of the transfer film 10L in a region corresponding to the space between the heating roller 46 and the peeling roller 48. That is, the printing material P is transported in the same direction as the direction of the transfer film 10L at the same speed in the region corresponding to the heating roller 46 and the peeling roller 48.

The moving means 50 has various available moving means of known articles. As an example, a flat bed, a roller conveyor, a belt conveyor, and the like, on which a printing material P is placed and moved, are exemplified.

In the image forming apparatus 32 shown in the drawing, the transfer film 10L is guided by the heating roller 46 and the peeling roller 48, is transported toward the moving means 50, that is, the printing material P (approaching region), is then transported in the same direction as the direction of the transport of the printing material P by the moving means 50, and is then transported in a direction in which the transfer film is separated from the moving means 50, that is, the printing material P (separating region) along a transport path having a substantially U shape.

The transfer film 10L is transported in the transport path having a substantially U shape by causing the support 12 to abut on the heating roller 46 and the peeling roller 48. In addition, the ink jet head 38, the heating and drying device 40, and the moving means 50 are disposed so as to face the ink permeation layer 18 in the transport path having a substantially U shape.

The jetting amount calculation unit 34 is a unit that calculates the amount of ink to be jetted to the transfer film 10L and supplies the calculated amount to the drive unit 36. The drive unit 36 is a unit that applies a drive voltage to the ink jet head 38 according to the amount of ink calculated by the jetting amount calculation unit 34 and jets the ink from the ink jet head 38.

The ink jet head 38 is a known ink jet head having a nozzle row that jets a yellow (Y) ink, a nozzle row that jets a magenta (M) ink, a nozzle row that jets a cyan (C) ink, and a nozzle row that jets a black (K) ink.

Accordingly, the ink jet head 38 may be a line head long in a direction perpendicular to the transport direction of the transfer film 10L or may be a carriage type head which moves in a direction perpendicular to the transport direction of the transfer film 10L. In addition to the ink jet head for printing a color image as shown in the example in the drawing, for example, the ink jet head may be an ink jet head for printing a monochrome image, may be a head for printing the same color image, or may be an ink jet head for jetting C, M, and Y inks.

As described above, while the transfer film 10L sent out from the film roll is transported in the direction toward the heating roller 46, that is, toward the printing material P, printing is performed on the transfer film by the ink jet head 38 on the upstream side of the heating roller 46.

On the transfer film 10L printed by the ink jet head 38, the jetted ink is heated and dried between the ink jet head 38 and the heating roller 46 by the heating and drying device 40.

Next, the transport direction of the transfer film 10L is changed by the heating roller 46 and the transfer film is heated from the support 12. The transfer film 10L is then transported in the same direction as the moving direction of the printing material P by the moving means 50. Then, the transport direction thereof is changed by the peeling roller 48 and the transfer film is transported in the direction in which the transfer film is separated from the moving means 50, that is, the printing material P and reaches the collecting roll.

Here, in the region corresponding to the transport path of the transfer film 10L between the heating roller 46 and the peeling roller 48, the moving means 50 is provided in a state in which the placement surface of the printing material P faces the transfer film 10L and the placement surface of the printing material P is separated from the transfer film 10L by a predetermined distance. The separation distance between the placement surface of the printing material P and the transfer film 10L between the heating roller 46 and the peeling roller 48 is slightly smaller than the thickness of the card-like printing material P.

As described above, the printing material P is placed on the moving means 50 and the moving means 50 moves at the same speed in the same direction as the direction of the transfer film 10L.

Accordingly, in a case where the printing material P is transported by the moving means 50, first, the transfer film 10L (ink permeation layer 18) and the printing material P are caused to abut each other (laminated), pressed, and further heated by the heating roller 46. By this heating and pressing, an ink permeation layer 18 is heat and adhered to the printing material P.

Thereafter, the transfer film 10L and the printing material P are transported between the heating roller 46 and the peeling roller 48 while being pressed.

In a case where the transfer film 10L reaches the peeling roller 48, the transport path is changed by the peeling roller 48 in a direction in which the transfer film is separated from the moving means 50, that is, the printing material P.

As described above, since the protective layer 14 contains the polymer having a glass transition temperature of 0° C. or higher in the transfer film 10L according to the embodiment of the present invention, the peelability between the support 12 and the protective layer 14 is good. Therefore, by the heating and adhesion of the ink permeation layer 18 and the printing material P and the change of the transport path of the transfer film 10L, the support 12 is peeled off from the protective layer 14 and the laminate including the ink permeation layer 18, the image receiving layer 16, and the protective layer 14 is transferred to the printing material P and only the support 12 is guided by the peeling roller 48 to be transported onto the collecting roll.

Further, in a case where the rear end portion of the printing material P in the transport direction reaches the peeling roller 48, the transfer film 10L (ink permeation layer 18) is not adhered to the printing material P. In addition, as described above, the thickness of the protective layer 14 in the transfer film 10L is 5 μm or less.

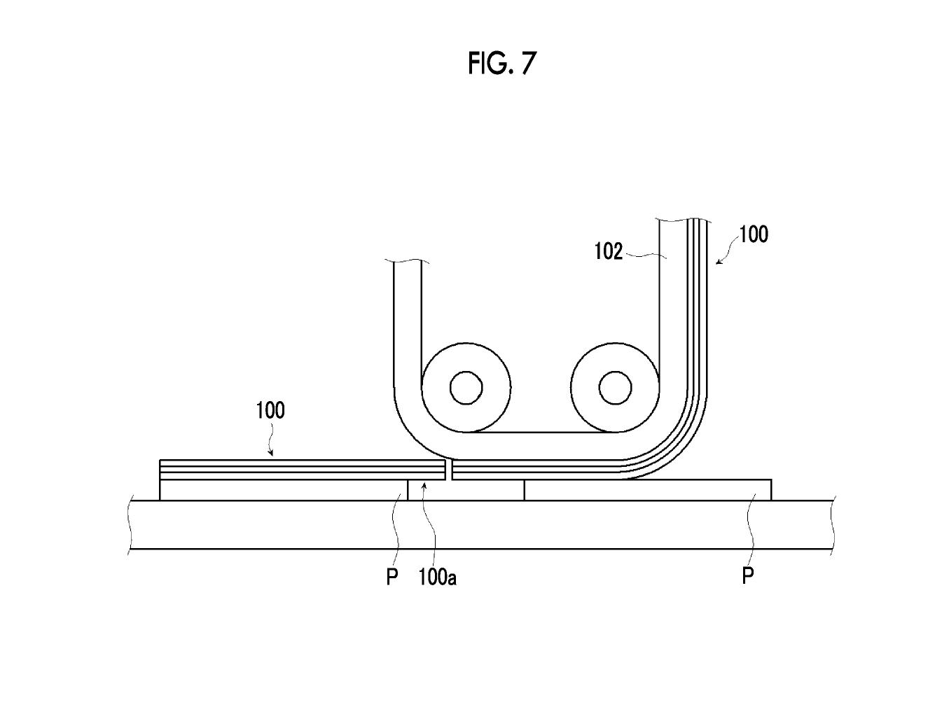

Therefore, the transfer film 10L transported by the peeling roller 48 in the direction in which the transfer film is separated from the moving means 50, that is, the printing material P is broken at the rear end portion in the transport direction of the printing material P that is not adhered to the printing material P, and the laminate including the ink permeation layer 18, the image receiving layer 16, and the protective layer 14 is transferred to only the surface of the printing material P to form an image on the printing material P. That is, according to the present invention, as conceptually shown in FIG. 7, the wing attachment 100a in which the laminate 100 including the ink permeation layer, the image receiving layer, and the protective layer is transferred to a region larger than the printing material P is not formed and the laminate including the ink permeation layer 18, the image receiving layer 16, and the protective layer 14 is transferred to only the surface of the printing material P.

In the image formation on the printing material P, it is needless to say that the printing timing is controlled at the printing by the ink jet head 38 such that the printing region on the transfer film 10L matches with the abutting region of the transfer film 10L and the printing material P.

As described above, in the image forming method according to the embodiment of the present invention using the transfer film 10L (transfer film 10) according to the embodiment of the present invention, the support 12 can be peeled off from the protective layer 14 with good peelability after the transfer film 10L is adhered to the printing material P, and an image can be formed on the printing material P by the ink jet method by transferring the laminate including the ink permeation layer 18, the image receiving layer 16, and the protective layer 14 to only the surface of the printing material P without forming the wing attachment 100a.

In addition, in the transfer film 10L according to the embodiment of the present invention, the protective layer 14 is formed on the surface of the support 12 formed of a resin film or the like, and finally, the support 12 is peeled off from the protective layer 14. Therefore, the surface of the support 12 formed of a resin film or the like having high smoothness is transferred to the surface of the protective layer 14 and the protective layer 14 has a good surface state. As a result, according to the transfer film 10L according to the embodiment of the present invention, it is possible to transfer a high quality image having a good surface state and high glossiness to the printing material P.

Further, the transfer film 10L according to the embodiment of the present invention has the ink permeation layer 18 separately from the image receiving layer 16, and the laminate including the ink permeation layer 18, the image receiving layer 16, and the protective layer 14 is adhered to the printing material P by the ink permeation layer 18. Therefore, the image receiving layer 16 which holds the image is not affected by adhesion, and as a result, a high quality image can be formed to the printing material P.

In the image forming method according to the embodiment of the present invention, the image formation result may be fed back by detecting the image formed on the printing material P.

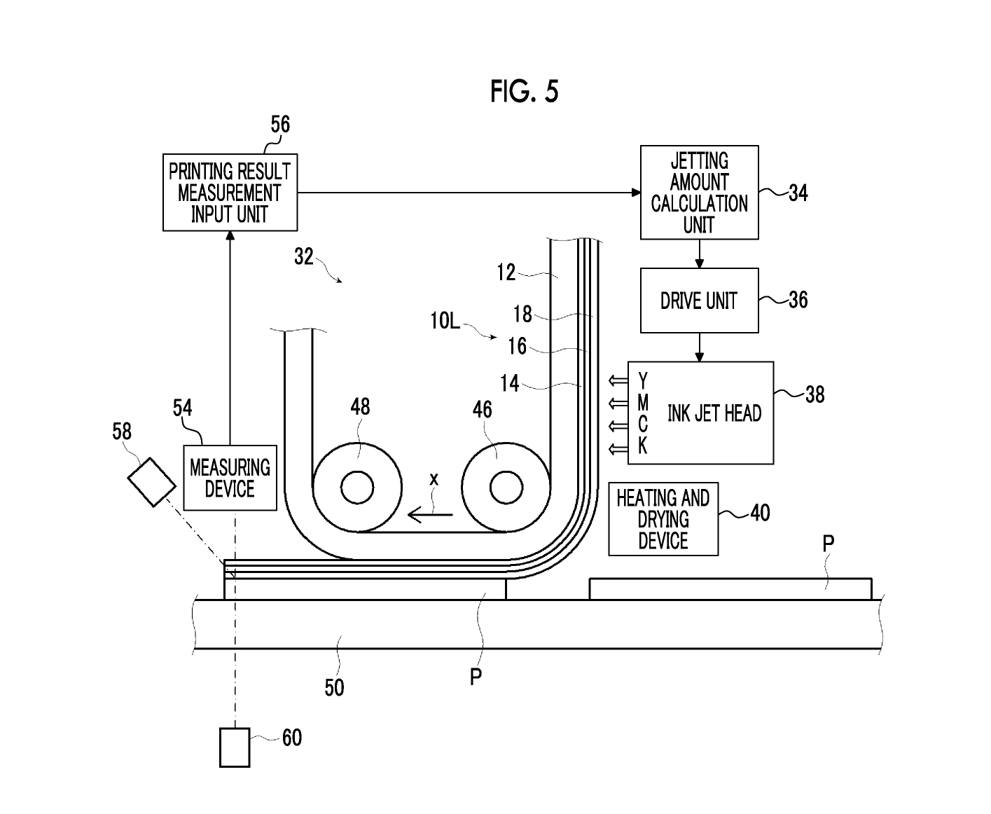

That is, as shown in FIG. 5, in the image forming apparatus shown in FIG. 4, a measuring device 54 is disposed on the downstream side of the peeling roller 48, a printing result measurement input unit 56 is connected to the measuring device 54, and the printing result measurement input unit 56 is connected to the jetting amount calculation unit 34.

The measuring device 54 measures light that is emitted by a light source 58 disposed on the side of the printing material P close to the transferred surface and is reflected on the image receiving layer 16. In addition, in a case where the printing material P is transparent, a light source 60 may be provided so as to sandwich the printing material P with the measuring device 54 and the light passing through the printing material P, the ink permeation layer 18, the image receiving layer 16, and the protective layer 14 may be measured by the measuring device 54.

The measured value obtained by the measuring device 54 is input to the printing result measurement input unit 56 and the image formed on the printing material P is detected. The image detection result by the printing result measurement input unit 56 is supplied to the jetting amount calculation unit 34.

The jetting amount calculation unit 34 obtains a corrected ink jetting amount for each region of the printing material P based on the image detection result supplied from the printing result measurement input unit 56 so as to realize the target color development. In accordance with the corrected ink jetting amount, the drive unit 36 drives the ink jet head 38 so that printing on the transfer film is performed.

Based on the ink jetting amount corrected by detecting the image formed on the printing material P and feeding back the image detection result in this manner, by performing printing on the transfer film 10L, even in a case where the initial ink jetting amount is poor, or even in a case where the physical properties of the ink and the transfer film 10L and the like are changed, it is possible to effectively suppress variation in color development.

Hereinafter, the transfer film and the image forming method according to the embodiments of the present invention have been described in detail. However, the present invention is not limited to the examples and of course, various improvements and modifications may be made without departing from the gist of the present invention.

### EXAMPLES

Hereinafter, the present invention will be described in more detail by giving specific examples of the present invention.

### Example 1

<Support>

A PET film having a width of 1000 mm, a thickness of 100 μm, and a length of 100 m (COSMOSHINE A4100, manufactured by Toyobo Co., Ltd.) was used as the support 12.

<Protective Layer>

<<Preparation of Coating Liquid for Forming Protective Layer>>

The following materials were stirred and mixed to prepare a coating liquid for forming a protective layer.

| | |
|---|---|
| Ion exchange water | 690 parts by mass |
| SUPER FLEX 170 | 300 parts by weight |
| (urethane-based resin emulsion, manufactured by | |
| Dai-ichi Kogyo Seiyaku Co., Ltd., polymer | |
| concentration: 33% by mass, glass transition | |
| temperature (Tg) of polymer: 75° C., | |
| solubility parameter (SP value) of polymer: 10.0 | |
| (cal/cm³)^{1/2}) | |
| 10% by mass aqueous surfactant solution | 10 parts by mass |
| (polyoxyethylene lauryl ether, EMULGEN 109P, | |
| manufactured by Kao Corporation) | |

<<Formation of Protective Layer>>

The coating liquid for forming a protective layer was applied to the highly smooth surface of the support 12 using a #20 wire bar in a coating amount of 3.5 g/m², and dried at 100° C. for 2 minutes. Thus, the protective layer 14 was formed on the surface of the support 12. The thickness of the formed protective layer 14 was 3 μm.

<Image Receiving Layer>

<<Preparation of Dispersion Liquid>>

A mixed liquid having the following composition was prepared.

| | | |
|---|---|---|
| Vapor phase method silica particles | 5.7 | parts by mass |
| (AEROSIL300SF75, manufactured by Nippon | | |
| Aerosil Co., Ltd.) | | |
| Ion exchange water | 22.7 | parts by mass |
| Dispersant | 0.5 | parts by mass |
| (SHAROL DC-902P, manufactured by Dai-ichi | | |
| Kogyo Seiyaku Co., Ltd., concentration: 51.5% | | |
| by mass, charge density: 6.6 meq/g) | | |
| Zirconyl acetate | 0.3 | parts by mass |
| (ZIRCOSOL ZA-30, manufactured by Dai-ichi | | |
| Kigenso Kagaku Kogyo Co., Ltd.) | | |

The mixed liquid was dispersed using a liquid-liquid collision type disperser (ULTIMAIZER, manufactured by Sugino Machine Limited) to prepare an intermediate dispersion liquid. The prepared intermediate dispersion liquid was heated at 45° C. and maintained at the temperature for 20 hours. Thus, a dispersion liquid was prepared.

<<Preparation of Coating Liquid for Forming Image Receiving Layer>>

The following materials were added to the prepared dispersion liquid and stirred and mixed to prepare a coating liquid for forming an image receiving layer.

| | |
|---|---|
| 5% by mass boric acid solution | 4.2 parts by mass |
| 8.1% by mass polyvinyl alcohol solution | 16.5 parts by mass |
| (PVA235: 7.0% by mass, PVA505: 1.1% by mass, | |
| manufactured by KURARAY Co., Ltd.) | |
| Diethylene glycol monobutyl ether | 0.4 parts by mass |
| (BUTYCENOL 20P, manufactured by Kyowa | |
| Hakko Chemicals Co., Ltd.) | |
| 10% by mass aqueous surfactant solution | 0.4 parts by mass |
| (polyoxyethylene lauryl ether, EMULGEN 109P, | |
| manufactured by Kao Corporation) | |
| Ion exchange water | 5.9 parts by mass |

<<Preparation of in-Line Liquid>>

The following materials were mixed to prepare an in-line liquid.

| | |
|---|---|
| Highly basic aluminum chloride | 3.7 parts by mass |
| (ALPINE 83, manufactured by | |
| TAIMEI Chemical Co., Ltd.) | |
| Ion exchange water | 6.3 parts by mass |

<<Preparation of Liquid Containing Basic Compound>>

The following materials were mixed to prepare a liquid containing a basic compound.

| | |
|---|---|
| Boric acid | 0.7 parts by mass |
| Ammonium carbonate | 5 parts by mass |
| (reagent grade 1, manufactured | |
| by KANTO KAGAKU) | |
| Zirconium compound | 0.3 parts by mass |
| (ZIRCOSOL AC-7, manufactured by Dai- | |
| ichi Kigenso Kagaku Kogyo Co., Ltd.) | |
| Ion exchange water | 93.4 parts by mass |
| 10% by mass aqueous surfactant solution | 0.6 parts by mass |
| (polyoxyethylene lauryl ether, EMULGEN | |
| 109P, manufactured by Kao Corporation) | |

<<Formation of Image Receiving Layer>>

The coating liquid for forming an image receiving layer and the in-line liquid were in-line mixed and the mixture was applied to the surface of the protective layer 14 previously formed using an extrusion die coater.

Specifically, the coating liquid for forming an image receiving layer and the in-line liquid were in-line mixed such that coating amount of the coating liquid was 90.5 g/m² and the coating amount of the in-line liquid was 7.4 g/m², and the mixture was applied.

The formed coating layer (coating film) was dried with a hot air dryer at 80° C. (wind speed 5 m/sec) until the solid content concentration reached 36% by mass. The coating layer showed constant rate drying during this period.

Immediately after drying the coating layer until the concentration of solid contents reached 36% by mass, the coating layer was immersed in the liquid containing a basic compound for 3 seconds, and 13 g/m² of the liquid containing a basic compound was applied to the coating layer having a concentration of solid contents of 36% by mass.

Further, the liquid was dried at 72° C. for 10 minutes and thus the image receiving layer 16 was formed on the surface of the protective layer 14. The thickness of the formed image receiving layer 16 is 20 μm.

<Ink Permeation Layer>

<<Preparation of Coating Liquid for Forming Ink Permeation Layer>>

The following materials were mixed to prepare a coating liquid for forming an ink permeation layer.

| | |
|---|---|
| Ion exchange water | 900 parts by mass |
| Carboxylated styrene butadiene latex | 50 parts by mass |
| (Nipol LX433C, manufactured by Zeon | |
| Corporation) | |
| 10% by mass aqueous surfactant solution | 0.6 parts by mass |
| (polyoxyethylene lauryl ether, EMULGEN | |
| 109P, manufactured by Kao Corporation) | |

<<Formation of Ink Permeation Layer>>

The coating liquid for forming an ink permeation layer was applied to the surface of the image receiving layer 16 previously formed using a #8 wire bar and dried at 40° C. for 10 minutes. Thus, the ink permeation layer 18 was formed on the surface of the image receiving layer 16 to prepare the transfer film 10.

### Example 2

<<Preparation of Coating Liquid for Forming Protective Layer>>

The following materials were stirred and mixed to prepare a coating liquid for forming a protective layer.

| | |
|---|---|
| Ion exchange water | 660 parts by mass |
| VINYBLAN 2685 | 330 parts by weight |
| (acrylic polymer, manufactured by Nissin | |
| Chemical Co., Ltd., polymer concentration: | |
| 30% by mass, Tg of polymer: 50° C., | |
| SP value of polymer: 9.5 (cal/cm³)^{1/2}) | |
| 10% by mass aqueous surfactant solution | 10 parts by mass |
| (polyoxyethylene lauryl ether, EMULGEN | |
| 109P, manufactured by Kao Corporation) | |

A transfer film was prepared in the same manner as in Example 1 except that the protective layer 14 was formed using this coating liquid.

### Example 3

<<Preparation of Coating Liquid for Forming Protective Layer>>

The following materials were stirred and mixed to prepare a coating liquid for forming a protective layer.

| | |
|---|---|
| Ion exchange water | 720 parts by mass |
| VINYBLAN 715S | 270 parts by weight |
| (vinyl chloride-based polymer (superfine | |
| particle type), manufactured by Nissin | |
| Chemical Co., Ltd., polymer concentration: | |
| 37% by mass, Tg of polymer: 25° C., SP | |
| value of polymer: 10.1 (cal/cm³)^{1/2}) | |
| 10% by mass aqueous surfactant solution | 10 parts by mass |
| (polyoxyethylene lauryl ether, EMULGEN | |
| 109P, manufactured by Kao Corporation) | |

A transfer film was prepared in the same manner as in Example 1 except that the protective layer 14 was formed using this coating liquid.

### Example 4

<<Preparation of Coating Liquid for Forming Protective Layer>>

The following materials were stirred and mixed to prepare a coating liquid for forming a protective layer.

| | |
|---|---|
| Ion exchange water | 790 parts by mass |
| SUMIKAFLEX 808HQ | 200 parts by weight |
| (ethylene-vinyl acetate-vinyl chloride | |
| copolymer resin emulsion, manufactured | |
| by Sumika Chemtex Co., Ltd., polymer | |
| concentration: 50% by mass, Tg of polymer: | |
| 25° C., SP value of polymer: 9.2 (cal/cm³)^{1/2}) | |
| 10% by mass aqueous surfactant solution | 10 parts by mass |
| (polyoxyethylene lauryl ether, EMULGEN | |
| 109P, manufactured by Kao Corporation) | |

A transfer film was prepared in the same manner as in Example 1 except that the protective layer 14 was formed using this coating liquid.

### Example 5

<<Preparation of Coating Liquid for Forming Protective Layer>>

The following materials were stirred and mixed to prepare a coating liquid for forming a protective layer.

| | |
|---|---|
| Ion exchange water | 790 parts by mass |
| SUMIKAFLEX 752HQ | 200 parts by weight |
| (ethylene-vinyl acetate copolymer resin | |
| emulsion, manufactured by Sumika | |
| Chemtex Co., Ltd., polymer concentration: | |
| 50% by mass, Tg of polymer: 15° C., | |
| SP value of polymer: 8.7 (cal/cm³)^{1/2}) | |
| 10% by mass aqueous surfactant solution | 10 parts by mass |
| (polyoxyethylene lauryl ether, EMULGEN | |
| 109P, manufactured by Kao Corporation) | |

A transfer film was prepared in the same manner as in Example 1 except that the protective layer 14 was formed using this coating liquid.

### Example 6

<<Preparation of Coating Liquid for Forming Protective Layer>>

The following materials were stirred and mixed to prepare a coating liquid for forming a protective layer.

| | |
|---|---|
| Ion exchange water | 623 parts by mass |
| SUPER FLEX 830HS | 367 parts by weight |
| (polyurethane-based, manufactured by | |
| Dai-ichi Kogyo Seiyaku Co., Ltd., polymer | |
| concentration: 30% by mass, Tg of polymer: | |
| 68° C., SP value of polymer: 10.0 (cal/cm³)^{1/2}) | |
| 10% by mass aqueous surfactant solution | 10 parts by mass |
| (polyoxyethylene lauryl ether, EMULGEN | |
| 109P, manufactured by Kao Corporation) | |

A transfer film was prepared in the same manner as in Example 1 except that the protective layer 14 was formed using this coating liquid.

### Example 7

<<Preparation of Coating Liquid for Forming Protective Layer>>

The following materials were stirred and mixed to prepare a coating liquid for forming a protective layer.

| | |
|---|---|
| Ion exchange water | 790 parts by mass |
| SUMIKAFLEX 850HQ | 200 parts by weight |
| (ethylene-vinyl acetate-vinyl chloride | |
| copolymer resin emulsion, manufactured by | |
| Sumika Chemtex Co., Ltd., polymer | |
| concentration: 50% by mass, Tg of polymer: | |
| 30° C., SP value of polymer: 9.2 (cal/cm³)^{1/2}) | |
| 10% by mass aqueous surfactant solution | 10 parts by mass |
| (polyoxyethylene lauryl ether, EMULGEN | |
| 109P, manufactured by Kao Corporation) | |

A transfer film was prepared in the same manner as in Example 1 except that the protective layer 14 was formed using this coating liquid.

### Example 8

<<Preparation of Coating Liquid for Forming Protective Layer>>

The following materials were stirred and mixed to prepare a coating liquid for forming a protective layer.

| | |
|---|---|
| Ion exchange water | 660 parts by mass |
| VINYBLAN 2687 | 330 parts by weight |
| (acrylic polymer, manufactured by Nissin | |
| Chemical Co., Ltd., polymer concentration: | |
| 30% by mass, Tg of polymer: 20° C., | |
| SP value of polymer: 9.5 (cal/cm³)^{1/2}) | |
| 10% by mass aqueous surfactant solution | 10 parts by mass |
| (polyoxyethylene lauryl ether, EMULGEN | |
| 109P, manufactured by Kao Corporation) | |

A transfer film was prepared in the same manner as in Example 1 except that the protective layer 14 was formed using this coating liquid.

### Example 9

<<Preparation of Coating Liquid for Forming Protective Layer>>

The following materials were stirred and mixed to prepare a coating liquid for forming a protective layer.

| | |
|---|---|
| Ion exchange water | 790 parts by mass |
| SUMIKAFLEX 830 | 200 parts by weight |
| (ethylene-vinyl acetate-vinyl chloride | |
| copolymer resin emulsion, manufactured by | |
| Sumika Chemtex Co., Ltd., polymer | |
| concentration: 50% by mass, Tg of polymer: | |
| 20° C., SP value of polymer: 9.2 (cal/cm³)^{1/2}) | |
| 10% by mass aqueous surfactant solution | 10 parts by mass |
| (polyoxyethylene lauryl ether, EMULGEN | |
| 109P, manufactured by Kao Corporation) | |

A transfer film was prepared in the same manner as in Example 1 except that the protective layer 14 was formed using this coating liquid.

### Example 10

<<Preparation of Coating Liquid for Forming Protective Layer>>

The following materials were stirred and mixed to prepare a coating liquid for forming a protective layer.

| | |
|---|---|
| Ion exchange water | 707 parts by mass |
| SUMIKAFLEX 830 | 100 parts by weight |
| SUPER FLEX 830HS | 183 parts by weight |
| 10% by mass aqueous surfactant solution | 10 parts by mass |
| (polyoxyethylene lauryl ether, EMULGEN | |
| 109P, manufactured by Kao Corporation) | |

A transfer film was prepared in the same manner as in Example 1 except that the protective layer 14 was formed using this coating liquid. In the coating liquid, the solid content ratio between SUMIKAFLEX 830 and the SUPER FLEX 830 is 1:1 by mass ratio.

### Example 11

<<Preparation of Coating Liquid for Forming Protective Layer>>

The following materials were stirred and mixed to prepare a coating liquid for forming a protective layer.

| | |
|---|---|
| Ion exchange water | 790 parts by mass |
| Nipol LX433C | 200 parts by weight |
| (carboxylated styrene butadiene latex, | |
| manufactured by Zeon Corporation, polymer | |
| concentration: 50% by mass, Tg of polymer: | |
| 50° C., SP value of polymer: 8.4 (cal/cm³)^{1/2}) | |
| 10% by mass aqueous surfactant solution | 10 parts by mass |
| (polyoxyethylene lauryl ether, EMULGEN | |
| 109P, manufactured by Kao Corporation) | |

A transfer film was prepared in the same manner as in Example 1 except that the protective layer 14 was formed using this coating liquid.

### Comparative Example 1

<<Preparation of Coating Liquid for Forming Protective Layer>>

The following materials were stirred and mixed to prepare a coating liquid for forming a protective layer.

| | |
|---|---|
| Ion exchange water | 700 parts by mass |
| CHEMIPEARL S300 | 290 parts by mass |
| (polyolefin aqueous dispersion, particle | |
| diameter: 0.5 μm, manufactured by Mitsui | |
| Chemicals, Inc., polymer concentration: 35% | |
| by mass, Tg of polymer: −20° C. or lower, SP | |
| value of polymer: 8.1 (cal/cm³)^{1/2}) | |
| 10% by mass aqueous surfactant solution | 10 parts by mass |
| (polyoxyethylene lauryl ether, EMULGEN | |
| 109P, manufactured by Kao Corporation) | |

A transfer film was prepared in the same manner as in Example 1 except that the protective layer 14 was formed using this coating liquid.

In all of Examples 2 to 11 and Comparative Example 1, the thickness of the protective layer 14 was 3 μm.

### Comparative Example 2

<<Preparation of Coating Liquid for Forming Protective Layer>>

The following materials were stirred and mixed to prepare a coating liquid for forming a protective layer.

| | |
|---|---|
| VINYBLAN 2687 | 990 parts by mass |
| 10% by mass aqueous surfactant solution | 10 parts by mass |
| (polyoxyethylene lauryl ether, EMULGEN | |
| 109P, manufactured by Kao Corporation) | |

A transfer film was prepared in the same manner as in Example 1 except that this coating liquid was used and the coating amount of the coating liquid was 10.29 g/m² to form a protective layer.

The film thickness of the protective layer was 9 μm.

[Evaluation]

The transfer films 10 of Examples 1 to 11 and Comparative Examples 1 and 2 thus prepared were evaluated for peelability, scratch resistance, and bendability (flexibility).

<Peelability>

Seven colors of yellow, magenta, cyan, blue, green, red, and gray, and white and black stripe patterns were printed on each of the prepared transfer films 10 using an ink jet printer, from the ink permeation layer 18. Next, the transfer film 10 was cut into a size of 65×100 mm.

As the printing material P, a PET-G card having a thickness of 0.76 mm and a size of 54×86 mm was laminated at the center of the surface of the cut transfer film 10 close to the ink permeation layer 18.

This laminate was heat-pressed by being sandwiched and transported by a pair of rollers of a silicone rubber transfer roll having a roll surface heated to 120° C. and a support roll, and the transfer film 10 (ink permeation layer 18) and the card were heated and adhered to each other. The linear pressure of heat-pressing was 1.5 kg/cm and the transport speed was 0.6 m/min.

Next, the support 12 was peeled off and the peelability was evaluated. The evaluation is as follows.

A: A case where the support 12 could be clearly peeled off without unpeeled portions and forming the wing attachment 100a.

B: A case where a very small wing attachment 100a was observed but the support 12 could be clearly peeled off without unpeeled portions.

C: A case where at least one of a small unpeeled portion of the support 12 which does not cause a problem on quality or a small wing attachment 100a which does not cause a problem on quality is formed.

D: A case where at least one of an unpeeled portion of the support 12 which causes a problem on quality or a small wing attachment 100a which causes a problem on quality is formed.

<Scratch Resistance>

In the evaluation of the peelability, after the support 12 was peeled off, the protective layer 14 was rubbed a #0000 steel wool by ten reciprocations while applying a load of 1 kg to evaluate scratch resistance. The evaluation is as follows.

A: A case where no scratches were observed on the protective layer 14.

B: A case where some scratches were observed on the protective layer 14.

C: A case where scratches were observed on the protective layer 14 but not noticeable and caused no problem on the quality.

D: A case where scratches causing a problem on the quality were observed on the protective layer 14.

<Bendability (Flexibility)>

The transfer film 10 was adhered to a PET film which become the printing material P in the same manner as in Example 1 except that the printing material P was changed to a card having a thickness of 0.76 mm and a PET film with an easily adhesive layer having a thickness of 100 μm was used, and the support 12 was peeled off.

Then, the PET film (printing material P) to which the laminate including the ink permeation layer 18, the image receiving layer 16, and the protective layer 14 was transferred was bent at 180° while the side of the protective layer 14 was directed to the outside to evaluate bendability. The evaluation is as follows.

A: A case where no cracks were observed on the protective layer 14.

B: A case where cracks were observed on the protective layer 14 but not noticeable and caused no problem on the quality.

C: A case where cracks causing a problem on the quality were observed on the protective layer 14.

The results are shown in the flowing table.

TABLE 1

| | Polymer of protective layer | | | | Evaluation | | |
|---|---|---|---|---|---|---|---|
| | | | SP value | Tg | | Scratch | |
| | Trade name | Kind | [(cal/cm³)^{1/2}] | [° C.] | Peelability | Resistance | Flexibility |
| Example 1 | SUPER FLEX | Urethane-based | 10 | 75 | A | B | A |
| | 170 | | | | | | |
| Example 2 | VINYBLAN | Acrylic | 9.5 | 50 | B | B | B |
| | 2685 | | | | | | |
| Example 3 | VINYBLAN | Vinyl | 10.1 | 25 | B | B | A |
| | 715S | chloride-based | | | | | |
| Example 4 | SUMIKAFLEX | Ethylene-vinyl | 9.2 | 25 | B | B | A |
| | 808HQ | acetate-vinyl | | | | | |
| | | chloride-based | | | | | |
| Example 5 | SUMIKAFLEX | Ethylene-vinyl | 8.7 | 15 | C | B | A |
| | 752HQ | acetate-based | | | | | |
| Example 6 | SUPER FLEX | Urethane-based | 10 | 68 | A | B | B |
| | 830HS | | | | | | |
| Example 7 | SUMIKAFLEX | Ethylene-vinyl | 9.2 | 30 | B | B | A |
| | 850HQ | acetate-vinyl | | | | | |
| | | chloride-based | | | | | |
| Example 8 | VINYBLAN | Acrylic | 9.5 | 20 | B | B | B |
| | 2687 | | | | | | |
| Example 9 | SUMIKAFLEX | Ethylene-vinyl | 9.2 | 20 | B | B | A |
| | 830 | acetate-vinyl | | | | | |
| | | chloride-based | | | | | |
| Example 10 | SUMIKAFLEX | Ethylene-vinyl | 9.2 | 20 | A | A | A |
| | 830 | acetate-vinyl | | | | | |
| | SUPER FLEX | chloride-based | 10 | 68 | | | |
| | 830HS | Urethane-based | | | | | |
| Example 11 | Nipol LX433 | SBR | 8.4 | 50 | B | C | A |
| Comparative | CHEMIPEARL | Polyolefin | 8.1 | −20° C. | D | D | A |
| Example 1 | S300 | | | or | | | |
| | | | | lower | | | |
| Comparative | VINYBLAN | Acrylic | 9.5 | 20 | D | B | B |
| Example 2 | 2687 | | | | | | |

Only in Comparative Example 2, the thickness of the protective layer was 9 μm and in other Examples, the thickness of the protective layer was 3 μm.

As shown in Table 1, in the transfer film 10 according to the embodiment of the present invention, the peelability with the support 12, and the scratch resistance and bendability (flexibility) of the protective layer 14 are good. Particularly, in Examples 1 and 6 in which the protective layer 14 contains a urethane-based polymer, the peelability is very excellent and further, in Example 10 in which the protective layer 14 contains two kinds of polymers, the peelability, the scratch resistance, and the bendability are very excellent.

In contrast, in Comparative Example 1 in which the glass transition temperature (Tg) of the polymer contained in the protective layer is less than 0° C., the peelability and the scratch resistance are poor. In addition, in Comparative Example 2 in which the thickness of the protective layer is more than 5 μm, a large wing attachment 100a is formed in a case of peeling off the support 12 and the peelability is poor.

From the above results, the effects of the present invention are obvious.

The present invention can be suitably used for image formation on a member not having an ink receiving capacity such as a resin product, a metal product, a coated cardboard product, a corrugated cardboard product, and the like.

### EXPLANATION OF REFERENCES

10: transfer film
12, 102: support
14: protective layer
16: image receiving layer
18: ink permeation layer
20: ink receiving particle
24: jetting surface
26: thermoplastic resin particle
28: tackifier particle
34: jetting amount calculation unit
36: drive unit
38: ink jet head
40: heating and drying device
46: heating roller
48: peeling roller
50: moving means
54: measuring device
56: printing result measurement input unit
58, 60: light source
100: laminate
100a: wing attachment
P: printing material

What is claimed is:

1. A transfer film comprising:
a support;
a protective layer that is formed on one surface of the support;
an image receiving layer that is formed on a surface of the protective layer; and
an ink permeation layer that is formed on a surface of the image receiving layer and has voids for allowing permeation of an ink,
wherein the protective layer has a thickness of 5 μm or less and contains a polymer having a glass transition temperature of 0° C. or higher.

2. The transfer film according to claim 1,
wherein a glass transition temperature of the polymer having a glass transition temperature of 0° C. or higher is 20° C. to 80° C.

3. The transfer film according to claim 1,
wherein a solubility parameter of the polymer having a glass transition temperature of 0° C. or higher is 8.5 (cal/cm³)^{1/2} or more.

4. The transfer film according to claim 1,
wherein the protective layer contains two or more kinds of the polymers having a glass transition temperature of 0° C. or higher.

5. The transfer film according to claim 1,
wherein the polymer having a glass transition temperature of 0° C. or higher is a urethane-based polymer.

6. An image forming method comprising:
a printing step of performing printing on the transfer film according to claim 1 from the ink permeation layer by an ink jet method;
an adhering step of causing the ink permeation layer of the transfer film subjected to printing to abut on a printing material and heating and adhering the transfer film and the printing material; and
a peeling step of peeling off the support from the transfer film adhered to the printing material.

7. The image forming method according to claim 6,
wherein the transfer film is long, and
the adhering step and the peeling step are performed while the long transfer film and the printing material are being transported in a longitudinal direction of the long transfer film at a same speed.

8. The image forming method according to claim 7,
wherein a transport path of the long transfer film has an approaching region which is directed in a direction in which the transfer film approaches the printing material, and a separating region which is provided on a downstream side of the approaching region and is directed in a direction in which the transfer film is separated from the printing material,
the adhering step is performed between the approaching region and the separating region, and
the peeling step is performed in the separating region.

9. The image forming method according to claim 7,
wherein the printing step is performed while the long transfer film is being transported in the longitudinal direction on an upstream side of a region where the adhering step is performed in a transport direction of the long transfer film.

10. The image forming method according to claim 8,
wherein the printing step is performed while the long transfer film is being transported in the longitudinal direction on an upstream side of a region where the adhering step is performed in a transport direction of the long transfer film.

11. The image forming method according to claim 6,
wherein the printing material has a card shape.
